(19) United States
(12) Patent Application Publication
(10) Pub. No.: US 2015/0287130 A1
(43) Pub. Date: Oct. 8, 2015

(54) SYSTEMS AND METHODS FOR ASSESSING DAMAGE OF RENTAL VEHICLE

(71) Applicant: Verc, Inc., Plymouth, MA (US)

(72) Inventors: John E. Vercollone, Pembroke, MA (US); Matt M. Vercollone, Norwell, MA (US); Ofri Marcus, Plymouth, MA (US)

(21) Appl. No.: 14/679,875

(22) Filed: Apr. 6, 2015

Related U.S. Application Data
(60) Provisional application No. 61/975,405, filed on Apr. 4, 2014.

(51) Int. Cl. G06Q 30/06; G06Q 30/04; G06K 9/20; G06Q 40/08; G06K 9/62; G06K 9/00

(52) U.S. Cl. CPC G06Q 30/0645; G06K 9/6215; G06K 9/00624; G06K 9/2081; G06Q 40/08; G06Q 30/04

(57) ABSTRACT

The present teachings generally relate to systems and methods for capturing and storing images that relate to the condition of a motor vehicle at two different times, e.g., the condition of a rental motor vehicle before it is removed from a rental agency and after it is returned to the agency. In some aspects, the systems and methods described herein can allow a rental agent to quickly capture the condition of a car with a time and location stamp to ensure that mileage, fuel level, and/or damage is recorded and stored for review and/or comparison with previous or later acquired images and review the images for charges to be assessed to the customer in an efficient and reliable manner. Although various aspects of the invention are discussed herein with reference to rental motor vehicles, the invention can have broader applicability, e.g., for use in valet services, rental of boats, motorcycles, etc.

### CROSS-REFERENCE TO RELATED APPLICATIONS

The present application claims the benefit of priority of U.S. Provisional Patent Application No. 61/975,405, filed Apr. 4, 2014, entitled “Systems and Methods for Assessing Damage of a Rental Vehicle,” the entire disclosure of which is hereby incorporated by reference in its entirety.

### SUMMARY

The present teachings generally relate to systems and methods for capturing and storing images that relate to the condition of a motor vehicle at two different times, e.g., the condition of a rental motor vehicle before it is removed from a rental agency and after it is returned to the agency. In some aspects, the systems and methods described herein can allow a rental agent to quickly capture the condition of a car with a time and location stamp to ensure that mileage, fuel level, and/or damage is recorded and stored for review and/or comparison with previous or later acquired images and review the images for charges to be assessed to the customer in an efficient and reliable manner. Although various aspects of the invention are discussed herein with reference to rental motor vehicles, the invention can have broader applicability, e.g., for use in valet services, rental of boats, motorcycles, etc.

In accordance with various aspects of the present teachings, a method of tracking damage to a rental vehicle is provided that includes receiving as input to a portable electronic device vehicle identification information of a rental vehicle, prompting a user of the portable electronic device to capture a first plurality of images of different views of the rental vehicle at a first time, the portable electronic device having a camera for capturing the first plurality of images, and storing the first plurality of images. The method can also include prompting the capture of a second plurality of images of different views of a rental vehicle at a second time and comparing the first plurality of images and the second plurality of images to determine a change in a condition of the rental vehicle between the first time and the second time. By way of example, comparing the first plurality of images and the second plurality of images can comprise simultaneously displaying at least one of the first plurality of images and at least one of the second plurality of images to determine if damage to the rental vehicle occurred between the first time and the second time, wherein the at least one of the first plurality of images and the at least one of the second plurality of images substantially correspond to the same view of the rental vehicle at the first time and the second time.

In various aspects, the first time can be at check-out of the rental vehicle and the second time can be at check-in (i.e., return by the renter) of the rental vehicle. In some related aspects, the method can also comprise displaying on the portable electronic device an option to purchase insurance coverage at check-out of the rental vehicle. By way of example, the option to purchase insurance coverage at check-out of the rental vehicle can be displayed after the customer confirms that the first plurality of images accurately reflect the condition of the car at check-out.

In various aspects, the method can include sending (e.g., emailing) the customer a bill for damage to the rental vehicle, the bill comprising one or more images of the first and second plurality of images (e.g., depicting before and after images of the damaged location).

In accordance with various aspects of the methods described herein, prompting the user of the portable electronic device to capture the first plurality of images of different views of the rental vehicle at the first time can comprise prompting the user to capture the first plurality of images in a particular order, and prompting the capture of the second plurality of images of different views of the rental vehicle at a second time can comprise prompting the capture of the second plurality of images in the same particular order.

In accordance with various aspects of the methods described herein, prompting the user of the portable electronic device to capture the first plurality of images of different views of the rental vehicle can comprise providing a representation of a motor vehicle in conjunction with a live field of view of the camera. By way of example, the representation of the motor vehicle comprises an outline of a portion of the motor vehicle overlaid on the live field view. In some aspects, the representation of the motor vehicle can correspond to the class of the rental vehicle or the particular make and model of the rental vehicle.

In accordance with various aspects of the present teachings, a system of tracking damage to a rental vehicle is provided that includes one or more digital data processors associated with at least one portable electronic device, the at least one portable electronic device having a camera for capturing images of a rental vehicle. In accordance with various aspects of some embodiments of the present teachings, the one or more digital data processors can be configured to receive vehicle identification information input at the at least one portable electronic device, prompt a user of the at least one portable electronic device to capture a first plurality of images of different views of the rental vehicle at a first time, and store the first plurality of images. The one or more digital data processors can also prompt the capture of a second plurality of images of different views of the rental vehicle at a second time, and simultaneously display at least one of the first plurality of images and at least one of the second plurality of images to determine a change in a condition of the rental vehicle between the first time and the second time, wherein said at least one of the first plurality of images and said at least one of the second plurality of images substantially correspond to the same view of the rental vehicle.

In various aspects, the one or more digital data processors comprises a first digital data processor associated with a first portable electronic device, the first digital data processor being configured to i) receive the vehicle identification information input at the first portable electronic device, ii) prompt the user of the first portable electronic device to capture the first plurality of images with the camera of the first portable electronic device, iii) prompt the capture of the second plurality of images with the camera of the first portable electronic device; and iii) simultaneously display at least one of the first plurality of images and at least one of the second plurality of images on the first portable electronic device. The first plurality of images can be stored locally and/or can be transmitted to a remote storage (e.g., database). By way of example, the first digital data processor can be configured to transmit the first plurality of images to a second digital data processor remote from the first digital data processor for storage.

In various aspects, the one or more digital data processors can comprise a first digital data processor associated with a first portable electronic device and a second digital data processor associated with a second portable electronic device. In such aspects, the first digital data processor can be configured to receive the vehicle identification information input at the first portable electronic device and prompt the user of the first portable electronic device to capture the first plurality of images with the camera of the first portable electronic device. Subsequently (e.g., upon return of the rental vehicle), the second portable electronic device can be used to perform check-in. For example, in various aspects, the second digital data processor of the second portable electronic device can be configured to prompt the capture of the second plurality of images with the camera of the second portable electronic device. In some related aspects, the second digital data processor can be configured to receive the first plurality of images and to simultaneously display at least one of the first plurality of images and at least one of the second plurality of images on the second portable electronic device.

In various aspects, the one or more digital data processors can further comprise a third digital data processor associated with a third electronic device (e.g., a laptop, a desktop computer, etc.), wherein the third electronic device is configured to receive the first plurality of images and the second plurality of images and to simultaneously display at least one of the first plurality of images and at least one of the second plurality of images on the third portable electronic device. In accordance with various aspects of the present teachings, the plurality of digital data processors can be communicatively coupled to one another (e.g., directly, wirelessly, or through a communications network (e.g., a LAN, Internet, etc.)).

In accordance with various aspects of the present teachings, the one or more digital data processors can be configured to prompt the user to capture the first plurality of images of different views of the rental vehicle in a particular order and to capture the second plurality of images of different views at the second time in the same particular order. Additionally or alternatively, the one or more digital data processors can be configured to overlay a representation of at least a portion of a motor vehicle on a live field of view of the camera so as to prompt the user of the first portable electronic device to capture at least one of the first plurality of images. By way of example, the representation can be an outline corresponding to the class of the rental vehicle or the particular make and model of the rental vehicle

In one aspect, a method of tracking damage to a rental vehicle is provided that includes receiving as input to a portable electronic device vehicle identification information, prompting a user of the portable electronic device to capture a first plurality of images of different views of a rental vehicle at a first time, storing the plurality of pictures, and prompting the capture of a second plurality of images of different views of a rental vehicle at a second time. At least one of the first plurality of images and at least one of the second plurality of images can be simultaneously displayed to determine if damage to the motor vehicle occurred between the first time and the second time, wherein the at least one of the first plurality of images and the at least one of the second plurality of images substantially correspond to the same view of the rental vehicle at the first time and the second time.

In one aspect, a method of tracking damage to a rental vehicle is provided that includes receiving as input to a portable electronic device vehicle identification information, prompting a user of the portable electronic device to capture a first plurality of images of different views of a rental vehicle at a first time in a particular order, and storing the plurality of pictures, and prompting the capture of a second plurality of images of different views of a rental vehicle at a second time in the same particular order. In some aspects, prompting the user to capture the first plurality of images of different views in the particular order comprises providing a representation of the rental vehicle in conjunction with a live field of view of a camera associated with the portable electronic device.

In one aspect, a system for tracking damage to a rental vehicle is provided that includes a portable electronic device having a camera for capturing a plurality of images of the rental vehicle. The portable electronic device comprises a digital data processor configured to receive as input vehicle identification information, prompt the user to capture a first plurality of images of different views of the rental vehicle, prompt the capture of a second plurality of images of different views of a rental vehicle, and simultaneously display to the user at least one of the first plurality of images and at least one of the second plurality of images to determine if damage to the motor vehicle occurred. The at least one of the first plurality of images and the at least one of the second plurality of images can substantially correspond to the same view of the rental vehicle at the different time.

In one aspect, a system for tracking damage to a rental vehicle is provided that includes a portable electronic device having a camera for capturing a plurality of images of the rental vehicle. The portable electronic device comprises a digital data processor configured to receive as input vehicle identification information, prompt the user to capture a first plurality of images of different views of the rental vehicle in a particular order, and prompt the capture of a second plurality of images of different views of the rental vehicle at a second time in the particular order. For example, the user can be prompted to capture the first plurality of images of different views in the particular order by displaying a representation of a vehicle in conjunction with a live field of view of the camera of the portable electronic device.

In one aspect, a system for tracking damage to a rental vehicle is provided that includes a digital data processor communicatively coupled to a portable electronic device having a camera for capturing a plurality of images of the rental vehicle. The portable electronic device can be configured to receive as input vehicle identification information, prompt the user to capture a first plurality of images of different views of the rental vehicle, prompt the capture of a second plurality of images of different views of a rental vehicle, and simultaneously display to the user at least one of the first plurality of images and at least one of the second plurality of images to determine if damage to the motor vehicle occurred, wherein the at least one of the first plurality of images and the at least one of the second plurality of images substantially correspond to the same view of the rental vehicle. In some aspects, the digital data processor can be remote from the portable electronic device. In accordance with various aspects, the digital data processor is configured to wirelessly receive the first plurality of images from the portable electronic device. In some aspects, the digital data processor can be associated with a database for storing the first plurality of images and the vehicle identification information.

### BRIEF DESCRIPTION OF THE DRAWINGS

A detailed description of various embodiments is provided herein below with reference, by way of example, to the following drawings, which are not necessarily to scale. It will be understood that the drawings are exemplary only and that all reference to the drawings is made for the purpose of illustration only, and is not intended to limit the scope of the embodiments described herein below in any way. For convenience, reference numerals may also be repeated (with or without an offset) throughout the figures to indicate analogous components or features.

FIG. 1, in schematic diagram, illustrates an exemplary system for capturing images and tracking the condition of a rental motor vehicle, in accordance with various aspects of the applicant's present teachings.

FIG. 2, in schematic diagram, illustrates an exemplary electronic device for use in the system of FIG. 1.

FIG. 3 illustrates an exemplary method of using the system of FIG. 1 to check-out a rental vehicle.

FIG. 4A illustrates an exemplary display of the electronic device of FIG. 1 for authenticating a user of the system.

FIG. 4B illustrates an exemplary display of the electronic device of FIG. 1 for entering unique vehicle identification information.

FIG. 5 illustrates an exemplary display of the electronic device of FIG. 1 for presenting the various views of the rental vehicle to be captured.

FIG. 6 illustrates an exemplary live camera view on the electronic device of FIG. 1 for prompting the user to acquire a photograph of the rental vehicle dashboard.

FIG. 7 illustrates an exemplary display on the electronic device of FIG. 1 for prompting the user to confirm that the photograph resulting from the view of FIG. 6 is acceptable.

FIG. 8 illustrates the exemplary display FIG. 5, updated to indicate that the user has confirmed that the photograph resulting from the view of FIG. 6 is acceptable.

FIGS. 9A, 9B, 9C, 9D, 9E, and 9F illustrate exemplary live camera views on the electronic device of FIG. 1, the live camera views having a silhouette for prompting the user to acquire a photograph of various views of the rental vehicle in accordance with various aspects of the applicant's present teachings.

FIG. 10 illustrates an exemplary display on the electronic device of FIG. 1 for prompting the user to confirm that the photograph resulting from the view of FIG. 9D is acceptable, and whether additional close-up photographs are desired.

FIG. 11 illustrates an exemplary method of using the system of FIG. 1 to check-in a rental vehicle.

FIG. 12 illustrates an exemplary display on the electronic device of FIG. 1 for prompting the user to confirm that the record retrieved corresponds to the vehicle to be checked in according to the method of FIG. 11.

FIG. 13 illustrates an exemplary display on the electronic device of FIG. 1 for prompting the user to acquire a photograph of a particular view of the rental vehicle, along with an option to indicate that damage is evident.

FIG. 14 illustrates an exemplary display on the electronic device of FIG. 1, presenting to the user before and after images of the motor vehicle for review by the rental agency.

### DETAILED DESCRIPTION

Those skilled in the art will understand that the methods, systems, and apparatus described herein are non-limiting exemplary embodiments and that the scope of the applicant's disclosure is defined solely by the claims. While the applicant's teachings are described in conjunction with various exemplary embodiments, it is not intended that the applicant's teachings be limited to such embodiments. Rather, the applicant's teachings encompass various alternatives, modifications, and equivalents, as will be appreciated by those of skill in the art. The features illustrated or described in connection with one exemplary embodiment may be combined with the features of other embodiments. Such modifications and variations are intended to be included within the scope of the applicant's disclosure.

Devices, systems, and methods are disclosed herein for capturing and storing images that relate to the condition of a motor vehicle at two different times, e.g., the condition of a rental motor vehicle before it is removed from a rental agency and after it is returned to the agency. In accordance with certain aspects of the present teachings, various aspects of the present teachings can provide for the efficient and accurate tracking of various characteristics of a rental vehicle by employing an integrated software approach based on a mobile device with a camera, such as a smartphone or tablet computer. In some aspects, the systems and methods described herein can allow a rental agent to quickly capture the condition of a car with a time and location stamp to ensure that mileage, fuel level, and/or damage is recorded and stored for review and/or comparison with previous or later acquired images. In various aspects, the systems described herein can allow a rental agency to more effectively capture the costs associated with fuel usage, miles travelled, and vehicle damage by creating database records that are accurate and easy to access. Moreover, because the system can allow the rental agency to more effectively track the use/condition of a rental vehicle, customers can be assured that any potential charges are associated with their particular use, while also providing an incentive for the customer to purchase collision or loss damage waiver (CDW/LDW) insurance coverage in view of the improved tracking.

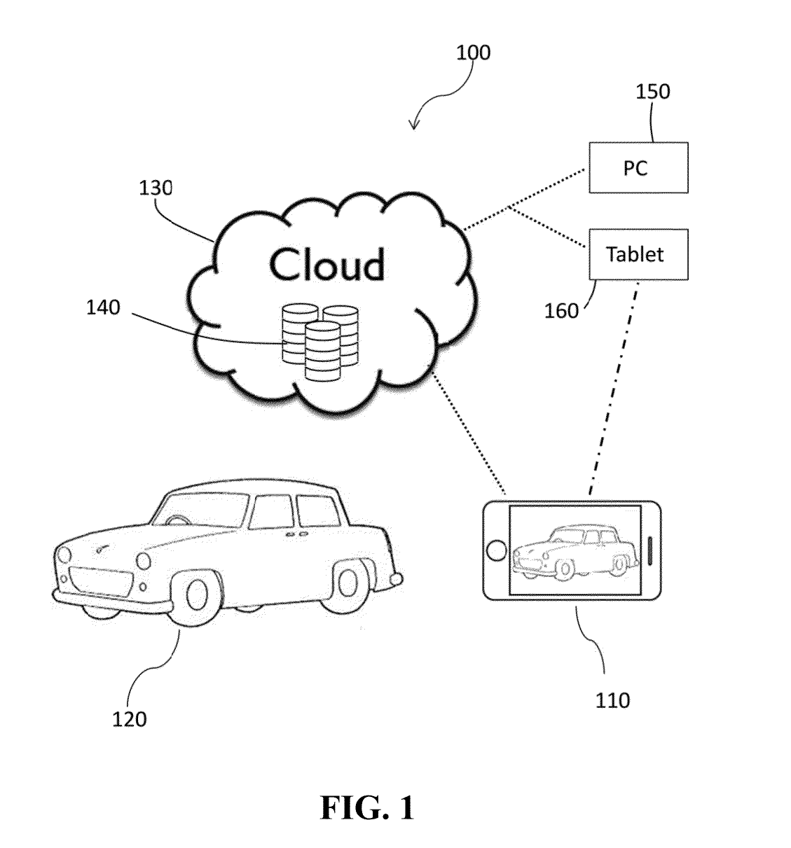

These and other objectives can be achieved by providing a system that generally includes an electronic device configured to capture, store, organize and/or transmit images of a rental vehicle, as well as a convenient platform for presenting to a user the various images (e.g., before and after images) to enable an accurate comparison of changes to the condition of the vehicle. With reference now to FIG. 1, one exemplary system 100 for tracking the characteristics of a vehicle is depicted. As shown in FIG. 1, the system 100 generally includes an electronic device 110 (e.g., a handheld mobile device) for capturing images and/or receiving input data from a user (e.g., rental agency staff) regarding characteristics of a vehicle 120. Such images and data can be stored and later accessed by a user (e.g. rental agency staff), for example, to assess changes to the condition of the vehicle during a rental agreement. In various aspects, the electronic device 110 can transmit (e.g., via wireless communication) the images and data to a remote digital data processor (e.g., cloud computing platform 130) and/or one or more additional electronic devices (e.g., personal computer 150, tablet computer 160) that enable the same user or a different user to access the images and data to assess the condition of a vehicle.

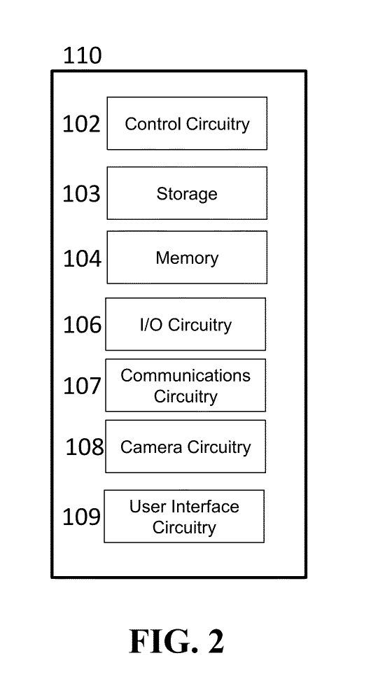

With reference now to FIG. 2, an exemplary electronic device 110 in accordance with various aspects of the present teachings is schematically depicted. The electronic device 110 can have a variety of configurations, but is generally configured to capture images and/or receive input data regarding, for example, the condition of a rental vehicle. By way of non-limiting example, the electronic device 110 can be a handheld computing device such as a personal digital assistant (PDA), a cellular phone (e.g., iPhone™ or Android™), a tablet computer (e.g., iPad™), or a digital camera, as well as any other suitable device presently known or hereafter developed and modified in light of the present teachings.

As shown in FIG. 2, the exemplary electronic device 110 can include control circuitry 102, storage 103, memory 104, input/output (I/O) circuitry 106, communications circuitry 107, a camera 108, and a user interface 109. It will be appreciated by one skilled in the art that the aforementioned hardware and various functions associated therewith can be combined or omitted, or alternatively, can be performed by a remote digital data processor in communication with the electronic device 110.

The control circuitry 102 is generally configured to control one or more of the functions of the electronic device 110, for example, to control various systems such as software or firmware applications, camera functionality, operating system (e.g., Android or iOS) or other circuitry such as the storage 103, memory 104, I/O circuitry 106, communications circuitry 107, camera 108, and user interface 109.

Storage 103 can include, for example, one or more storage media such as an optical hard-drive, a solid state hard drive, permanent (ROM) memory, or any other current or future memory medium. Examples of data that may be stored in the storage medium 103 include application data, software applications (“apps”), firmware, user login information and user preferences, transaction information (e.g., data related to a rental agreement), vehicle rental databases, images (e.g., photographs) of vehicles, and any other suitable information, data, or combinations thereof. Memory 104 can include semi-permanent solid state memory such as RAM, cache memory, or any other type of memory suitable for temporarily storing data. Memory 104 can also be used for storing the same type of data as that stored in the storage medium 103. It will be appreciated that in some embodiments, the memory 104 and storage 103 can be combined as a single storage medium.

In some embodiments, I/O circuitry 106 can be used to convert data from analog to digital or vice versa. For example, I/O circuitry 106 may receive and convert sound from a microphone (e.g., which can be built into the digital device 110) into digital format for storage in storage media 103 or memory 104. Such sound data may be used in some embodiments to record a voice message or description of a photograph of a rental vehicle, which can be associated with the electronic record. Furthermore, the I/O circuitry 106 can be used to convert input data from the camera 108 into digital data for storage on the device 110 or in the cloud 130 (e.g., on servers 140 in the cloud 130 as shown in FIG. 1).

Those skilled in the art will appreciate that there may be multiple I/O circuits supporting various features of the electronic device 110. In some embodiments the I/O circuitry 108 can include display circuitry (e.g., a screen) for providing a display to a user. For example, this display circuitry can include a user interface 109 (e.g., touchscreen) that is incorporated into the electronic device 110. The display circuitry can be operative to display content (e.g., application screens for applications implemented on the electronic device 110, information regarding ongoing communications operations, information regarding incoming communications requests, or device operation screens) under the direction of control circuitry 102.

Electronic device 110 can also include communications circuitry 107 operative to connect the electronic device 110 to a remote digital data processor via a communications network and/or to transmit data communications from electronic device 110 to the other devices. For example, communications circuitry 110 can be employed for communicating over a communications network, using any suitable communications protocol such as, for example, Wi-Fi (e.g., a 802.11 protocol), Bluetooth®, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol, to a remote digital data processor (e.g., cloud computing platform 130 or a local server). In some aspects, communications circuitry 107 can create a short-range communications network using a short-range communications protocol (e.g., via Wi-Fi or Bluetooth®) to wirelessly connect directly to one or more other devices within a communications network (e.g., digital data processors such as a personal computer 150 or tablet computer 160).

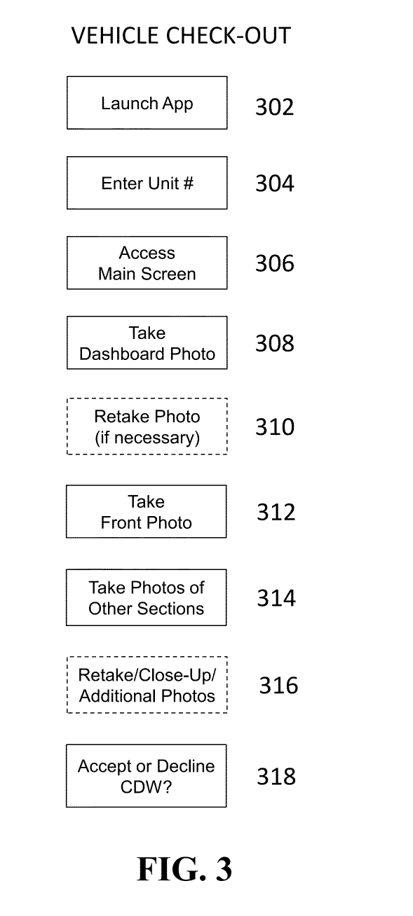

In accordance with various aspects of the present teachings, the electronic device 110 can also include an integrated software application (e.g., an “app”) according to the present teachings to facilitate the acquisition and/or display of images and data related to the vehicle. Various exemplary aspects of the integrated software application will now be described in conjunction with the system 100 to demonstrate by way of non-limiting example the use of the system 100 in processing a rental car using the application software as illustrated in FIG. 3, which illustrates an exemplary process for capturing a vehicle's relevant characteristics at the time of checking a vehicle out from a rental agency.

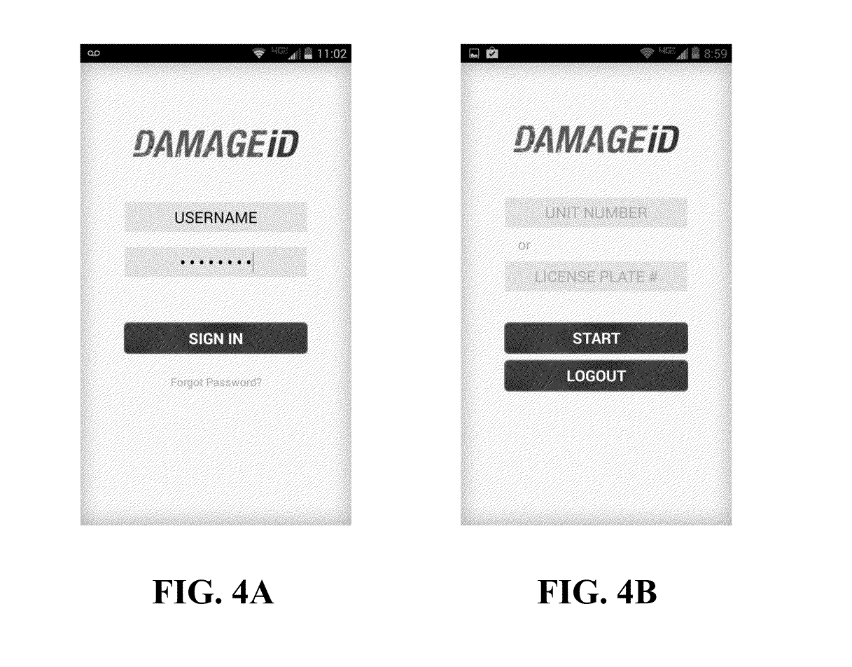

Upon a customer entering a car rental office, a rental agent generally goes through a standard rental procedure from behind the counter including, for example, offering collision damage waiver (CDW) insurance. Upon completion of the rental agreement, the agent and the customer can then inspect the vehicle. As shown in step 302 of FIG. 3, a user (e.g., the agent) can launch the software application, and optionally, sign-in to access the system using the exemplary log-in screen depicted in FIG. 4A. Upon launch and authentication, the software application can present the user with buttons labeled “Unit ID” and “License Plate #” to prompt the user to enter vehicle identifying information (step 304), as shown in FIG. 4B. Additionally or alternatively, the user can utilize the electronic device 110 to scan a number or symbol on the vehicle (e.g., a barcode or QR code) to input the vehicle identification information into the application.

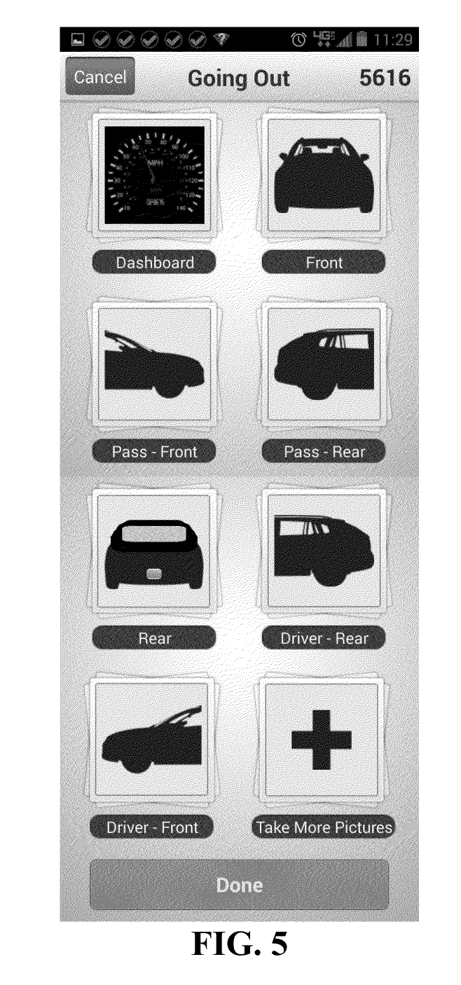

After entering the vehicle identification information and pressing “START” on the user interface provided by the application, the user can be presented with a main screen, as shown for example, in FIG. 5, which presents the user with a menu, icons, words, and/or photos that indicate various views of the vehicle to be captured. Alternatively, for example, the screen may display a single icon (e.g., an icon representing the dashboard) to prompt the user to capture a particular view. The user may click on any of the icons to proceed to a screen that allows the user to take a photograph of any view of the vehicle but preferably the view that matches the icon.

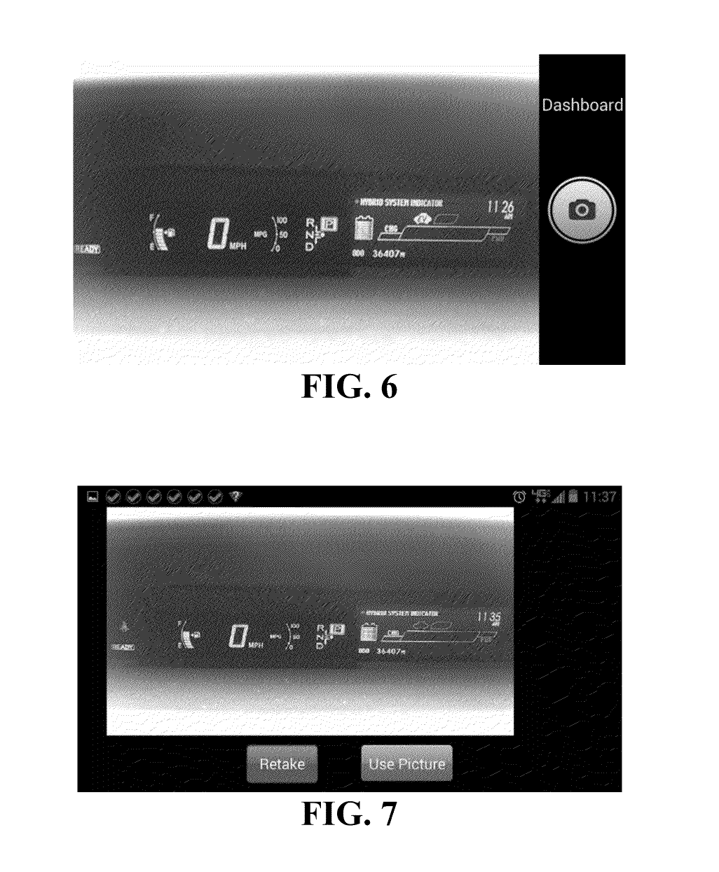

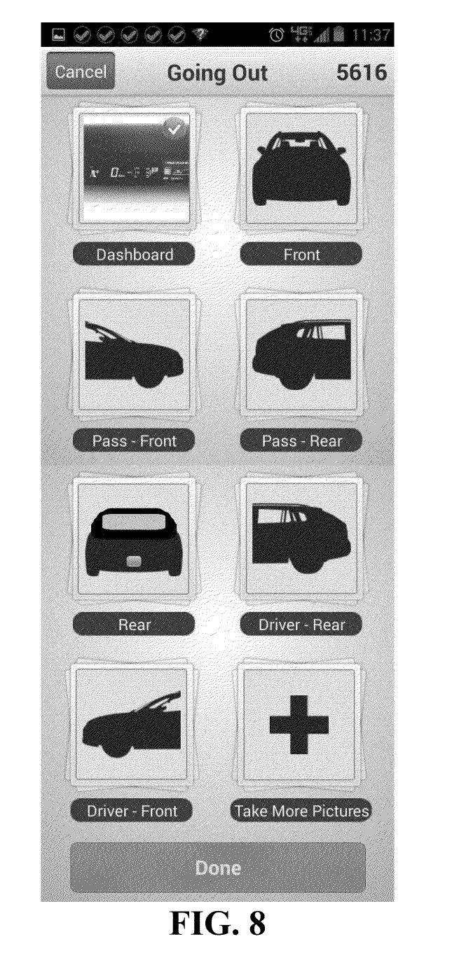

After selecting the dashboard icon, for example, the display may present a camera view from the camera of the electronic device 110, and optionally present a text prompt indicating that the agent should take a picture of the dashboard so as to record fuel level and mileage (step 308), as shown in FIG. 6, or alternatively prompting the user to input the fuel level and milelage (e.g., via the touchscreen). Optionally, the display may then present the user with the photograph and ask that the user to confirm that the picture is acceptable, as shown in FIG. 7. If the user finds the photo acceptable, the user can accept the photo (e.g., by pressing the “Use Picture” button). If the initial image is blurry, out of focus, has poor lighting or shows a reflection, for example, the user can opt to retake the photo by pressing the “Retake” button such that the display switches to the live camera view for recapture (step 310).

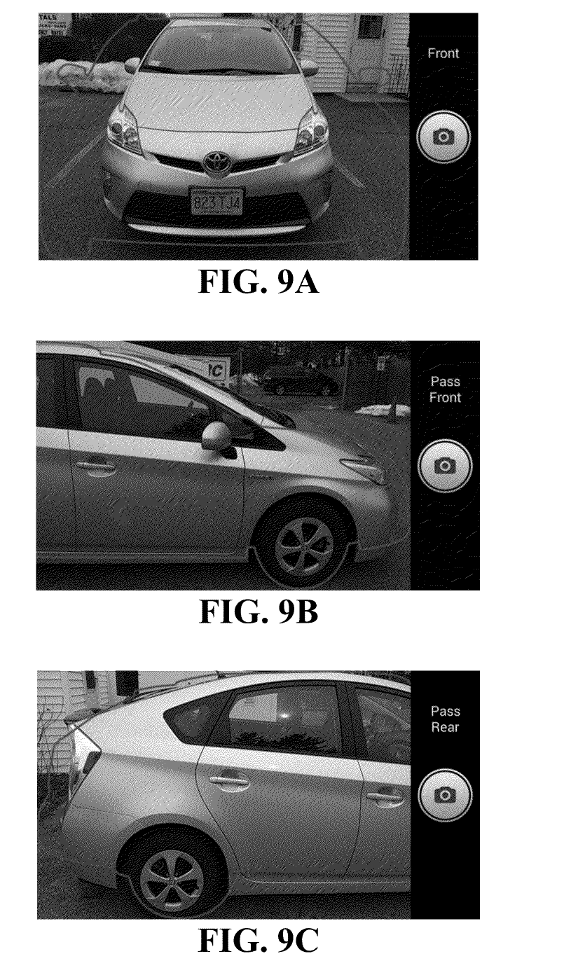

As shown in FIG. 8, after the user confirms that the dashboard photo is acceptable, the display can return to the main screen, which in the exemplary display now includes a partial or full image of the dashboard photo replacing the icon of the dashboard depicted in FIG. 5. Additionally or alternatively, the display can provide a status indicator (e.g., a check mark) to indicate that this particular view has been captured.

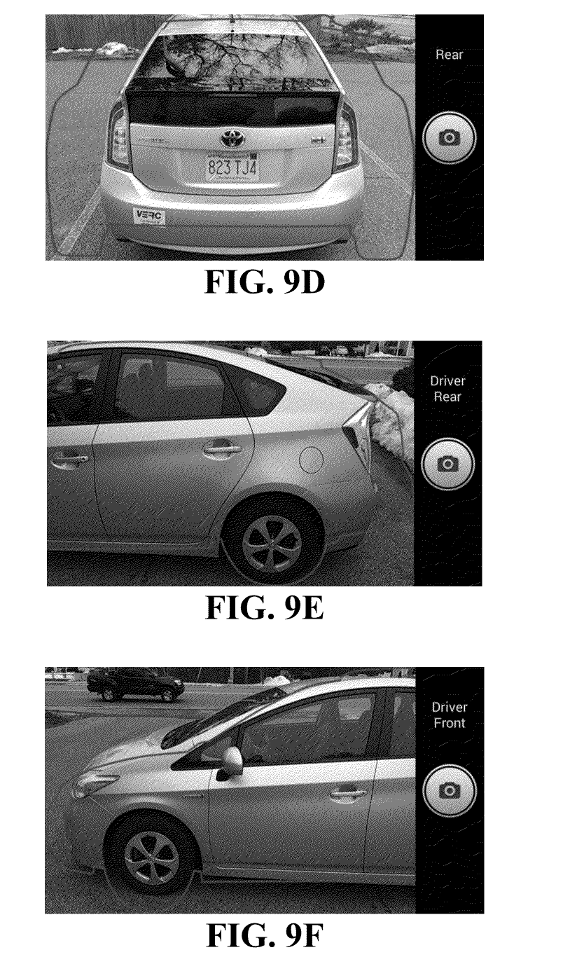

From the main screen, the user can then click on any of the icons to take a photograph of another view of the vehicle. By way of example, after the user selects the “Front” view icon, the display of the electronic device 110 can again present a live camera view, along with a prompt indicating that the agent take a picture of the front of the vehicle (step 312), as shown in FIG. 9A. After the user confirms that the photograph corresponding to the front view is acceptable, for example, the display can then return to main screen (e.g., updated to reflect that the front view has been captured) to allow the user to select another view (step 312). The user can then proceed to access live camera screens for each of the remaining views of the vehicle (step 314) as shown in each of the “Pass Front” (FIG. 9B), “Pass Rear” (FIG. 9C), “Rear” (FIG. 9D), “Driver Rear” (FIG. 9E), and “Driver Front” (FIG. 9F) displays. It will be appreciated that while the process depicted in FIG. 3 indicates that the “Front” step (i.e., step 312) is after the “Dashboard” step (i.e., step 310) and before the other views (i.e., step 314), photographs may be acquired in any sequence as selected by the user, for example.

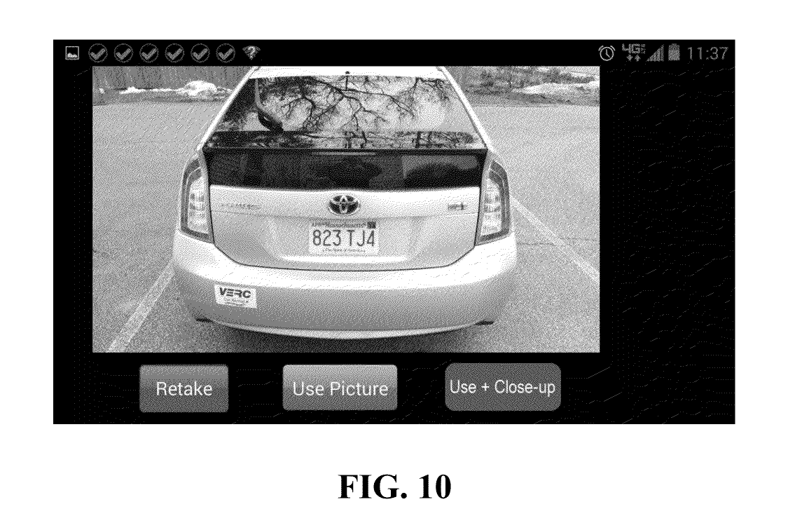

As indicated in step 316 of FIG. 3, after the user has captured each of the six prompted views around the perimeter of the vehicle, the application can also prompt the user to re-take any unacceptable photographs, take close-up photos to document damage noticed by the agent or customer, or take any additional photos (e.g., the roof, internal damage to the vehicle). It will further be appreciated that these various options can be presented to the user at different points throughout the exemplary process depicted in FIG. 3. By way of example, and with reference now to FIG. 10, after the user has captured the “Rear View” of FIG. 9D, the display may present the photograph to the user to confirm that the image is acceptable, as discussed above with reference to FIG. 7. Additionally, as shown in FIG. 10, the user can also be presented with the option to accept the initial photo and take one or more additional close-up photos to document specific issues (e.g., window cracks, dents, scratches) that can be associated with the particular section of the vehicle that is the subject of the zoomed-out photograph. For example, if the user notices a dent on the right side of the rear bumper while obtaining the photograph depicted in FIG. 10 (and the photograph is acceptable), selection of the option “Use+Close-up” can save the initial rear view and present the user with a live camera view to record in detail the damage. After sufficient close-up images of the damage have been captured, the user can then be returned to the main screen to enable completion of the remainder of the prompted views. In some embodiments, after the user has captured acceptable photos of each of the main views, the user can select an icon to capture any additional damage (e.g., the plus “+” icon of FIG. 8).

In some aspects, the main screen can indicate to the user whether multiple photos have been stored for each particular view, and can allow the user to access the various photos prior to completion of the check-out transaction. By way of example, standard rear-view photos and close-up photos of particular damage can be associated with the “Rear” icon for immediate review and/or future access upon review, as discussed in detail below. In various aspects, close-up photos can be associated with a particular view, for example, by selecting the associated view, with the application prompting the user to take additional pictures associated with that section of the vehicle). Additionally or alternatively, miscellaneous photos and close-up photo can be accessible under a separate icon (e.g., an “Others” icon).

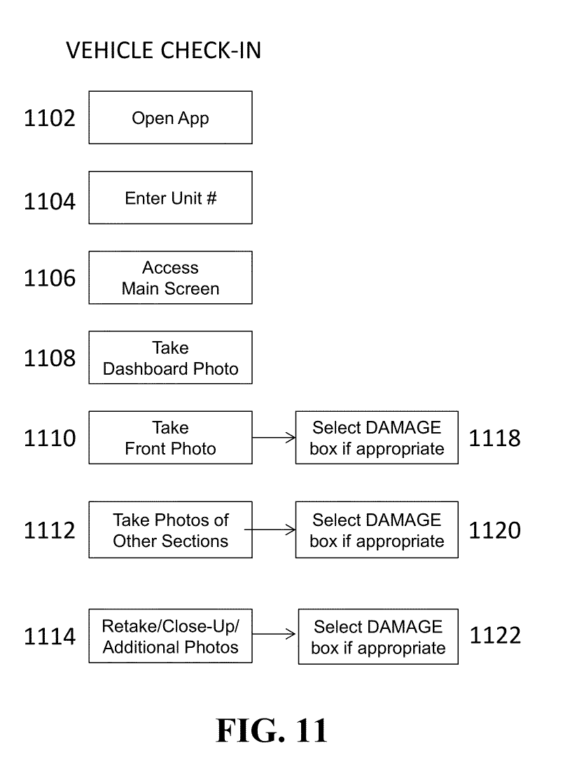

If no additional documentation is necessary or the agent and customer are satisfied with the pictures (e.g., after the agent and/or customer confirms that the first plurality of images accurately reflect the condition of the car at check-out), the user can select the “Done” button on the main screen. In accordance with various aspects of the present teachings, the display may then present another option to accept or decline collision damage waiver (CDW) insurance on the application interface (e.g., step 318). As shown in FIG. 11, for example, the display presents a green “Accept CDW” button and a red “Decline CDW” button to be selected by the agent or customer (e.g., if the customer did not purchase CDW initially). By again being presented the option to purchase CDW after being made aware of the detailed process in which the car is examined prior to taking possession of the rental car (e.g., by accompanying the user during documentation), the customer may wish to accept CDW.

With reference again to FIGS. 9A-9F, in some aspects the live camera view can provide an outline or silhouette of a vehicle (e.g., a generic vehicle or car) so as to guide the user in framing the photograph of the rental vehicle. By way of non-limiting example, the outlines depicted in FIGS. 9A-9F provide a guide for framing the perimeter of the section of the vehicle that is to be photographed. When a particular photo icon is selected from the main screen, for example, the application advances to a live camera screen and the outline corresponding to the selected view can be made visible on the display (e.g., whether or not the vehicle is in the field of view). The outline guides the user to place the proper section of the car in the image frame, thus helping the user to take the requested photo. The outline can also provide a guideline for sizing the image, e.g., the user can accurately employ the outline to ensure that the section to be imaged is entirely within or substantially within the outline. It will be appreciated that though the shape of the outline need not be precisely matched to the shape of any particular vehicle, in some aspects, the overlaid outline can represent a particular class of vehicle corresponding to the vehicle to be rented (e.g., a sedan, hatchback, truck, van, or SUV), or alternatively, the particular make and model of the rental vehicle (e.g., Toyota Prius, Honda Accord, Ford Explorer). In various aspects, the user of the electronic device can be prompted to select the class or make and model of the rental vehicle, or alternatively, the outline can be automatically determined, for example, based on the vehicle identifying information (e.g., based on information from step 304). In any case, the outline can help ensure that the photographs are taken at the same distance away from the vehicle, which may provide for more consistent and faster comparisons between images of the same section of the vehicle taken at different times (e.g., before and after rental).

Rather than returning to the main screen after a user confirms that a photo of a particular view is acceptable such that the user can select another view as discussed above, the software application can alternatively automatically prompt the user to acquire an image from a different section of the vehicle. For example, the prompts can provide a predetermined order of views to be taken (e.g., as if the user were walking around the car clockwise). In some embodiments, the application can display to the user with a sequence of outlines, each corresponding to a particular portion of the vehicle to prompt the user to acquire images of those portions. That is, the application may automatically present the user with a live camera view depicting a silhouette of another view to be captured, for example, upon the user indicating that the previous picture is acceptable. For example, after the user confirms that the image corresponding to the view of the front of the vehicle as depicted in FIG. 9A is acceptable, the display may then automatically provide a live view of the camera, with the silhouette of the front, passenger side being depicted as in FIG. 9B. Similarly, after confirming that the photograph of the front, passenger side is acceptable, the user can then be similarly prompted to take pictures of the remaining views in a pre-defined sequence.

It should also be appreciated that the sequence of prompts need not require user confirmation of the previous picture. Rather, the next prompt and/or silhouette may appear automatically, for example, as soon as the user takes a photograph. In such a case, the user may then be prompted at the end of the sequence to review the photographs and confirm their suitability. To the extent that the photograph of one or more views is deemed unacceptable, the user can indicate the need for a re-take, for example, such that the application again prompts the user for the remaining images.

Upon completion of the check-out procedure, the photographs and other data can be stored locally on the electronic device 110 (e.g., within storage 103) and/or can be transmitted to one or more remote databases (e.g., servers 140 on the cloud 130, PC 150, tablet 160) for later access or review.

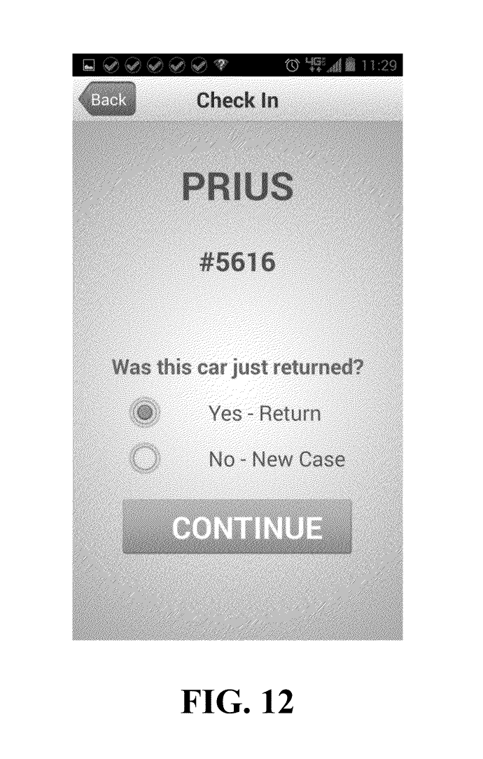

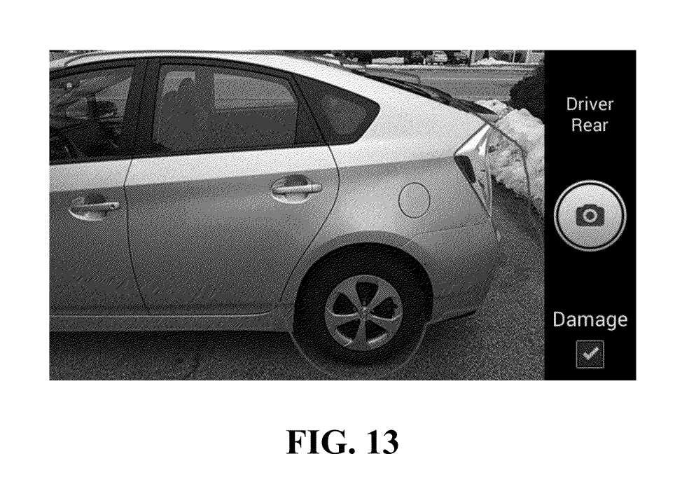

In accordance with various aspects of the present teachings, the same or a different electronic device 110 with the software application described herein running thereon can additionally be used in checking in a rental vehicle upon its return to the rental agency. With reference now to FIG. 11, an exemplary check-in procedure will be described with reference to the system shown in FIG. 1. The user (e.g., rental agent) can conduct a procedure similar to the check-in procedure in order to capture images and/or data related to a vehicle's relevant characteristics when the customer returns the rental vehicle 120 to the rental agency (or to a different location). As with check-out, the user can begin the check-in process by opening the application (step 1102), and entering vehicle identification information (e.g., unit number) (step 1104). In light of the input of the unique identifier, the application can access (e.g., retrieve from its storage 103 or receive from the cloud 130) record and/or image data associated with the vehicle and prompt the user to confirm that the proper record was retrieved, as shown in FIG. 12. Upon confirmation (e.g., by hitting “CONTINUE”), the electronic device 110 can display a main screen (step 1106) that presents to the user the various views of the vehicle to be captured, a single icon to prompt the user to capture a particular view, or a live camera view from the electronic device 110 that prompts the user to take a photograph of a particular view. In some aspects, the user may click on any of the icons of the main screen to proceed to a screen that allows the user to take a photograph of any view of the vehicle but preferably the view that matches the icon. By way of example, as in step 1108, the user can take a “Dashboard” photo to record fuel level and mileage upon return (or allow the user to enter this data manually). Optionally, the display can then present the user with the photograph and ask that the user to confirm that the picture is acceptable. If the user finds the photo acceptable, the user can accept the photo (e.g., by pressing the “Use Picture” button), or else retake the picture as discussed otherwise herein.

As discussed above with reference to the check-out procedure, the user can then be prompted to take a photograph of a particular view in steps 1108, 1110, and 1112. Optionally, the user can also be given the option of retaking a poor quality photo, take a close-up of noticeable damage, or take any other photo as necessary (step 1114). As in the check-out process, the camera image may be framed with a silhouette of a vehicle to encourage the user to take consistent pictures of the vehicle sections. While obtaining the image of a particular view or confirming that the image is acceptable, the application can also present the user with an option to select a “DAMAGE” box in the application (as shown in FIG. 12) if there is noticeable damage in any section of the car (steps 1118 and 1120). The “DAMAGE” box can also be presented and selected in conjunction with a close-up image (step 1122). As discussed in detail below, the damage designation can serve to highlight certain photographs so that they may be reviewed by the user or any other rental agency staff member (e.g., staff members local or remote to the instant location of the rental car return).

Upon completion of the check-in procedure, the photographs and other data can be stored locally on the electronic device 110 (e.g., within storage 103) and/or can be transmitted to one or more remote databases (e.g., servers 140 on the cloud 130, PC 150, tablet 160) for later access or review. For example, at the end of the workday, the agency staff can access the records of the cars that have been returned to the rental agency on the particular day and can review the records for any issues related to fuel usage, mileage, or data. It will be appreciated that the data can be accessed by the staff via an electronic device 110 or any other computing devices or displays including, for example, the PC 150 or a tablet computer 160 communicatively coupled to the electronic device directly, wirelessly, or through a communications network (e.g., a LAN, Internet, etc.). In some aspects, when a user is ready to review a record, the user can input the particular vehicle identification number to retrieve a particular record. The user can then be presented with a display depicting the various data associated with the check-out or check-in process of the particular vehicle. By way of example, for each of the particular views prompted during the check-out and check-in process, the user can be presented with the associated photographs. In various aspects, the application will present the before and after photographs to the user of the electronic device 110 (or another electronic device) in a side-by-side manner to allow for an easy comparison between the condition of the vehicle at the various time points. In some aspects, the reviewer may be presented with all of the photographs in a side-by-side manner, or initially, for example, only before and after photographs of a particular view in which the agent identified potential damage during check-in.

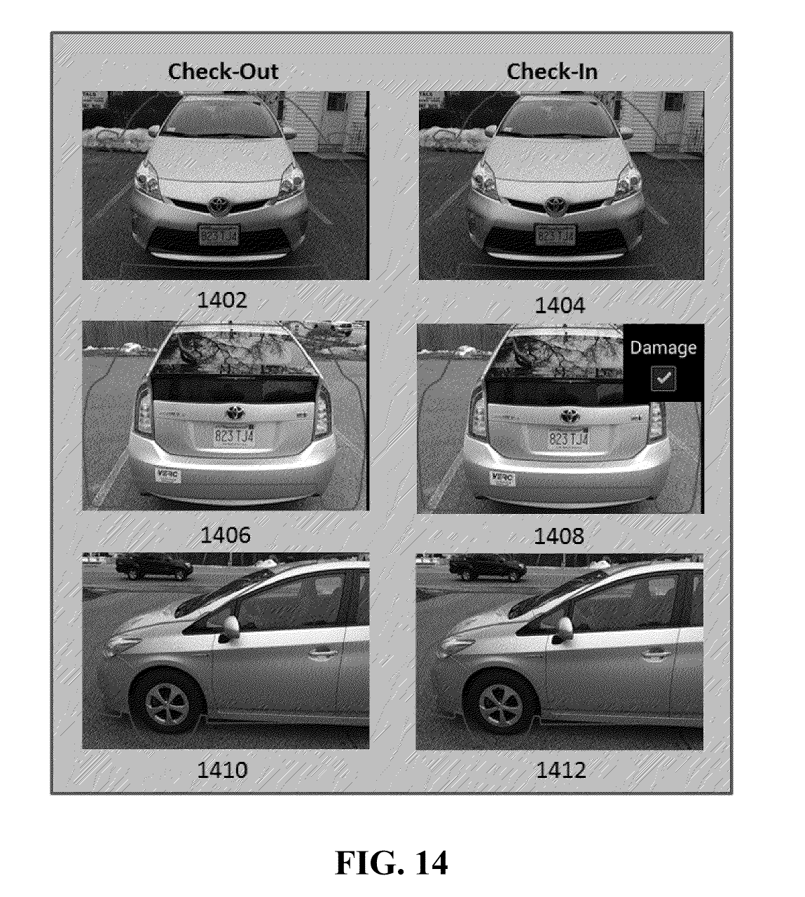

With reference now to FIG. 14, an exemplary display of a set of side-by-side images is shown. For example, when a user is presented with check-out and check-in images 1402-1412, the user can select to examine images 1406 and 1408 in additional detail in view of the “Damage” designation present in image 1408, which indicate that the image was tagged as such when it was taken. The reviewing staff can thus examine the photo in more detail, zoom in on the photo, or access an additional close-up image (if available). The reviewing staff can then use the images to estimate charges that may be levied on the customer due to the damage. Additionally and alternatively, the reviewing staff member may access the vehicle itself for direct inspection in order to verify the photographs and to more accurately estimate any charges that may be passed on to the customer.

In some aspects, the integrated software application can allow a user to back up the data contained in or generated by the application. For example, a user can choose between uploading to a cloud service, emailing one or more photos (or associating the photos depicting the damage to a bill to be sent to a customer), or backing up or restoring previous cycles. Alternatively, some or all of the data evaluation procedures may be conducted directly from the electronic device 110.

Although the preferred embodiments of the present invention have been described herein, the above description is merely illustrative. Further modification of the invention disclosed herein will occur to those skilled in the respective arts and all such modifications are deemed to be within the scope of the invention as defined.

It will be appreciated that various of the above-disclosed features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the following claims.

1. A method of tracking damage to a rental vehicle, comprising:
receiving as input to a portable electronic device vehicle identification information of a rental vehicle;
prompting a user of the portable electronic device to capture a first plurality of images of different views of the rental vehicle at a first time, the portable electronic device having a camera for capturing the first plurality of images;
storing the first plurality of images;
prompting the capture of a second plurality of images of different views of a rental vehicle at a second time; and
comparing the first plurality of images and the second plurality of images to determine a change in a condition of the rental vehicle between the first time and the second time.

2. The method of claim 1, wherein comparing the first plurality of images and the second plurality of images comprises simultaneously displaying at least one of the first plurality of images and at least one of the second plurality of images to determine if damage to the rental vehicle occurred between the first time and the second time, wherein the at least one of the first plurality of images and the at least one of the second plurality of images substantially correspond to the same view of the rental vehicle at the first time and the second time.

3. The method of claim 1, wherein the first time is at check-out of the rental vehicle and the second time is at check-in of the rental vehicle.

4. The method of claim 3, further comprising displaying on the portable electronic device an option to purchase insurance coverage at check-out of the rental vehicle.

5. The method of claim 4, wherein displaying the option to purchase insurance coverage at check-out of the rental vehicle occurs after the customer confirms that the first plurality of images accurately reflect the condition of the car at check-out.

6. The method of claim 1, further comprising sending to a customer a bill for damage to the rental vehicle, the bill comprising one or more images of the first and second plurality of images.

7. The method of claim 1, wherein prompting the user of the portable electronic device to capture the first plurality of images of different views of the rental vehicle at the first time comprises prompting the user to capture the first plurality of images in a particular order, and wherein prompting the capture of the second plurality of images of different views of the rental vehicle at a second time comprises prompting the capture of the second plurality of images in the particular order.

8. The method of claim 1, wherein prompting the user to capture the first plurality of images of different views in the particular order comprises providing a representation of a motor vehicle in conjunction with a live field of view of the camera.

9. The method of claim 8, wherein the representation of the motor vehicle comprises an outline of a portion of the motor vehicle overlaid on the live field view.

10. The method of claim 9, wherein the representation of the motor vehicle corresponds to one of a class of the rental vehicle and a particular make and model of the rental vehicle.

11. A system for tracking damage to a rental vehicle, comprising:
one or more digital data processors associated with at least one portable electronic device, the at least one portable electronic device having a camera for capturing images of a rental vehicle, said one or more digital data processors configured to:
receive vehicle identification information input at the at least one portable electronic device;
prompt a user of the at least one portable electronic device to capture a first plurality of images of different views of the rental vehicle at a first time;
store the first plurality of images;
prompt the capture of a second plurality of images of different views of the rental vehicle at a second time; and
simultaneously display at least one of the first plurality of images and at least one of the second plurality of images to determine a change in a condition of the rental vehicle between the first time and the second time, wherein said at least one of the first plurality of images and said at least one of the second plurality of images substantially correspond to the same view of the rental vehicle.

12. The system of claim 11, wherein the one or more digital data processors comprises a first digital data processor associated with a first portable electronic device, the first digital data processor being configured to:
receive the vehicle identification information input at the first portable electronic device;
prompt the user of the first portable electronic device to capture the first plurality of images with the camera of the first portable electronic device;
prompt the capture of the second plurality of images with the camera of the first portable electronic device; and
simultaneously display at least one of the first plurality of images and at least one of the second plurality of images on the first portable electronic device.

13. The system of claim 12, wherein the first digital data processor is configured to transmit the first plurality of images to a second digital data processor remote from the first digital data processor for storage.

14. The system of claim 11, wherein the one or more digital data processors comprises a first digital data processor associated with a first portable electronic device having a first camera and a second digital data processor associated with a second portable electronic device having a second camera;
wherein the first digital data processor is configured to:
receive the vehicle identification information input at the first portable electronic device; and
prompt the user of the first portable electronic device to capture the first plurality of images with the first camera; and
wherein the second digital data processor is configured to prompt the capture of the second plurality of images with the second camera.

15. The system of claim 14, wherein the second digital data processor is configured to receive the first plurality of images, and wherein the second digital data processor is configured to simultaneously display at least one of the first plurality of images and at least one of the second plurality of images on the second portable electronic device.

16. The system of claim 14, wherein the one or more digital data processors further comprises a third digital data processor associated with a third electronic device, wherein the third electronic device is configured to receive the first plurality of images and the second plurality of images, and wherein the third digital data processor is configured to simultaneously display at least one of the first plurality of images and at least one of the second plurality of images on the third portable electronic device

17. The system of claim 11, wherein the one or more digital data processors comprises a plurality of digital data processors that are communicatively coupled to one another.

18. The system of claim 11, wherein the one or more digital data processors is configured to prompt the user to capture the first plurality of images of different views of the rental vehicle in a particular order, and to prompt the capture of the second plurality of images of different views at the second time in the particular order.

19. The system of claim 11, wherein the one or more digital data processors is configured to overlay a representation of at least a portion of a motor vehicle on a live field of view of the camera so as to prompt the user of the first portable electronic device to capture at least one of the first plurality of images.

20. The system of claim 19, wherein the outline corresponds to one of a class of the rental vehicle and a particular make and model of the rental vehicle.
